(19) United States
(12) Patent Application Publication
(10) Pub. No.: US 2005/0024591 A1
(43) Pub. Date: Feb. 3, 2005

(54) Reflective polarization valve engine and projection display using the same

(76) Inventors: Jan-Tian Lian, Keelung (TW); June-Jei Huang, Taoyuan (TW)

Correspondence Address: BIRCH STEWART KOLASCH & BIRCH, PO BOX 747, FALLS CHURCH, VA, 22040-0747, US

(21) Appl. No.: 10/680,193

(22) Filed: Oct. 8, 2003

(30) Foreign Application Priority Data
Jul. 29, 2003 (TW) 092120639

(51) Int. Cl. G03B 21/14

(52) U.S. Cl. 353/20

(57) ABSTRACT

Reflective polarization valve engine and projection display are disclosed. Instead of prism PBS, the projector applies wire-grid polarizers with advantages of higher heat-resistance, no limitation of the incident angle and no birefringence effects, to provide excellent contrast luminance. The light source in the projector utilizes an elliptical lamp under a telecentric optical system to achieve higher efficiency and avoid color gradient. In addition, the light paths are in special arrangement. The original beam is first splitted into RGB, and then proceeding with color-recombining right after being polarized via wire-grid polarizers and analyzed by reflective polarization valves. Hence, the analyzed beams finally are recombined images with superior performances.

### BACKGROUND OF THE INVENTION

1. Field of Invention

The present invention relates to a projection display and its optical engine with reflective polarization valves, and more particularly, to a projection device that utilizes a wire-grid polarizer, a telecentric optical system and specific arrangement of light path, which have the beams proceeding with color-recombining right after being analyzed by reflective polarization valves.

2. Related Art

In the prior art, a LCOS (Liquid Crystal on Silicon) projector that uses LCOS as reflective polarization valve, is similar to LCD projector in portions of light-guiding, light-splitting and color-combining. The only difference is that the LCOS projector further applies prism PBS (Polarization Beam Splitter). PBS is a binding prism of two 45° isosceles right angle prisms. PBS reflects the S-polarized light of an incident beam and allows the P-polarized light to pass through. In general, the original beam emitting from a light source is splitted into R, G and B beams via dichroic mirrors. S-polarized beams are reflected into LCOS panels when the R, G, and B beams penetrate through their PBSs respectively. If the LCOS is under light state, the S-polarized beams are transformed into P-polarized beams. Consequently, we can obtain images via combining the analyzed P-polarized beams and projecting onto a screen.

However, the application of a PBS causes some defects.

First, the PBS has low heat-resistance so that birefringence effect and decreasing of contrast luminance are formed due to heat-expansion of the PBS. Second, the PBS has limitation in incident angles of beams. It is necessary to apply parallel light sources to increase the efficiency while using the PBS. In consequence, the light path is longer and the total volume becomes larger. Moreover, in current design of the light path, beams analyzed by reflective light valves (e.g. LCOS panels) have to pass PBSs for polarizing transformation before proceeding with color recombining. Therefore, the light path becomes longer and causes energy loss. In addition, the PBS reduces the purity of polarized beams because of its unstability, which makes an unsatisfactory performance of image combination.

Except the PBS, there are other substitute prisms in unique shapes in the prior art. However, they are expensive and have low heat-resistance.

In some special projection systems, peculiar optical elements such as Color-Quad, Color-Corner or X-plate are applied. Comparatively, because these optical elements' unique shapes are hard to manufacture and have a lack of general uses, they are difficult for mass production and thereby have higher costs.

### SUMMARY OF THE INVENTION

In view of the foregoing, the invention wants to solve the problems of low image performance and high cost when using the PBS, prisms of unique shapes and peculiar optical elements.

The above problems have been solved by the present invention via providing a reflective polarization valve engine and a projection display. The projection display comprises a light source, a dichroic mirror, a reflective polarization valve, a wire-grid polarizer, a color-recombining unit and a projecting unit. The light source provides a polarized white beam. The dichroic mirror splits the white beam into color beams with different colors. The reflective polarization valve receives the polarized color beams and selectively reflects the color beams. The wire-grid polarizer is located between the dichroic mirror and the reflective polarization valve. The wire-grid polarizer allows the polarized color beams of one specific polarity to pass through, and reflects the polarized color beams of another specific polarity. The polarized color beams reflected from the reflective polarization valve under light state are reflected via the wire-grid polarizer for color recombining. The color-recombining unit combines the color beams reflected from the wire-grid polarizer. The projecting unit projects the combined color beams to form images.

In short, the invention achieves advantages as follows:
A. Provides higher contrast luminance of image.
B. By means of dichroic mirror, the light path is capable of change direction. Meanwhile, the entire light paths are highly concentrated and have more selectivity of arrangement, so as to achieve a projection system of smaller volume.
C. The wire-grid polarizer is produced via a semi-conductor producing procedures to provide an easier manufacturing process and lower costs.
D. Instead of drawbacks of color gradients, the invention achieves better color uniformity.
E. Specific arrangement of light paths provides better image performance.

### BRIEF DESCRIPTION OF THE DRAWINGS

The invention will become more fully understood from the detailed description given herein below illustration only, and is thus not limitative of the present invention, and wherein:

FIG. 1 is a structural diagram of a projection display provided by a preferred embodiment according to the invention;

FIG. 2 is an explanation diagram of a wire-grid polarizer used in the preferred embodiment; and

FIG. 3 is an energy-wavelength diagram of curves, showing a better performance in image luminance via combining red and blue beams under S-polarized state, and a green beam under P-polarized state.

### DETAILED DESCRIPTION OF THE INVENTION

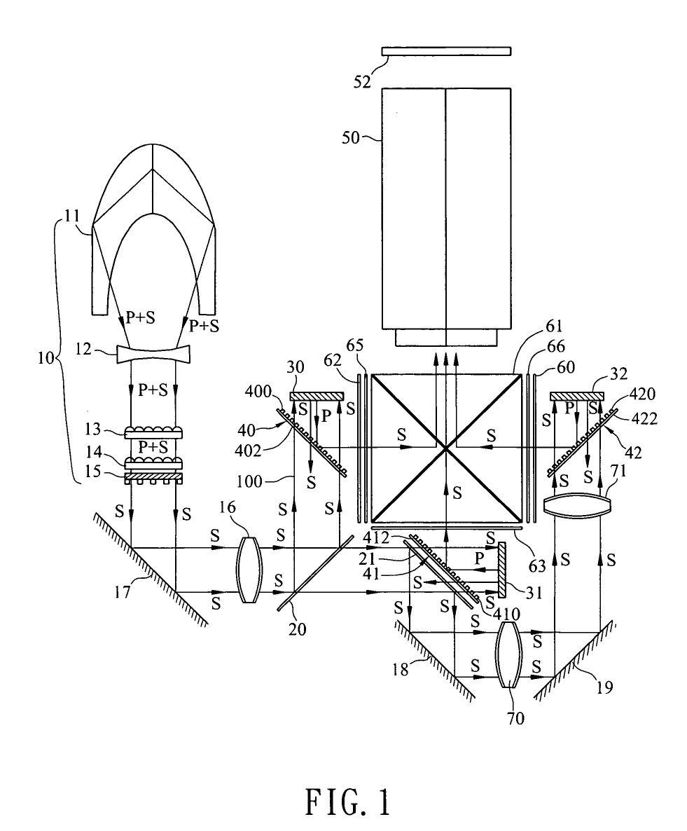

Please refer to FIG. 1, which shows a structural diagram of a projection display provided by a preferred embodiment according to the invention. The projection display comprises light source 10, dichroic mirror 20 and 21, reflective polarization valve 30, 31 and 32, wire-grid polarizer 40, 41 and 42, color-recombining unit 61 and projecting unit 50. The characteristic of the elements, their relations and the arrangement of light paths are illustrated in the following description.

Light source 10 provides a polarized white beam. It is a telecentric optical system, which includes a white lamp 11, a divergent lens 12, a lens array 13, 14 and a P/S converter 15. The white lamp 11 is an elliptical lamp of high efficiency. The white beam generated by the white lamp 11 first passes through the divergent lens 12 and then the lens array 13, 14. Next, the white beam goes through the S-polarized transformation via the P/S converter 15. After being splitted, the beams focus on the reflective polarization valve 30, 31, 32 via the focusing lens 16, 70 and 71, to form parallel S-polarized beam. Reflector 17, 18, and 19 modify the directions of the light paths.

The dichroic mirror 20 and 21 split the white beam into color beams of three original colors, red, green and blue.

The reflective polarization valve 30, 31 and 32 provided in the preferred embodiment are LCOS panels, but RLCD (reflective liquid crystal display) is practical as well. The reflective polarization valve 30, 31 and 32 receive the polarized color beams and selectively reflect the color beams.

The wire-grid polarizer is a polarization-transforming element produced via processes of semiconductors, such as ProFlux™ provided by Moxtek Inc. The advantages include a higher heat-resistance, no limitation of the incident angle and no birefringence effects, to enhance the contrast luminance of the system. Moreover, because the wire-grid polarizer allows a larger incident angle, convergent light sources such as an elliptical lamp can be applied to shorten the light paths, achieve higher efficiency and a system of smaller volume. In consequence, the system is much easier to manufacture and has lower costs.

The wire-grid polarizer 40, 41 and 42, skew in angle 45° to the light axis 100, are located between the dichroic mirror 20, 21 and the reflective polarization valve 30, 31, 32. In detail, the wire-grid polarizer 40 is located between the dichroic mirror 20 and the reflective polarization valve 30; the wire-grid polarizer 41 is located between the dichroic mirror 21 and the reflective polarization valve 31; the wire-grid polarizer 42 is located between the dichroic mirror 21 and the reflective polarization valve 32.

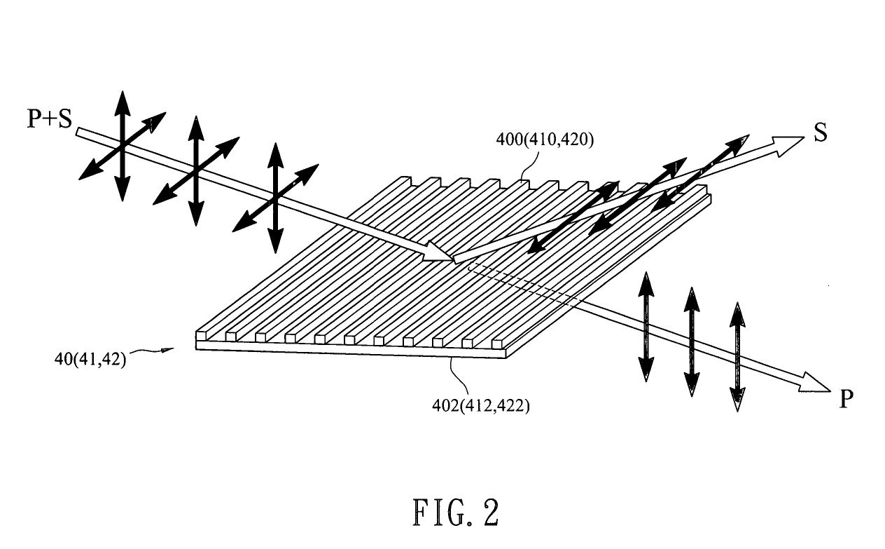

With reference to FIG. 2, the wire-grid polarizer 40 (41, 42) has a polarizing surface 400 (410, 420). The polarizing surface 400 (410, 420) faces the reflective polarization valve 30 (31, 32). The opposite surface 402 (412, 422) of the wire-grid polarizer 40 (41, 42) allows the color beams mentioned above to pass through and project onto the reflective polarization valve 30 (31, 32). Furthermore, the polarizing surface 400 (410, 420) splits the beams reflected from the reflective polarization valve 30 (31, 32) according to their polarity. In short, the wire-grid polarizer 40 (41, 42) reflects P-polarized beams but allows S-polarized beams to pass through, or reflects S-polarized beams but allows P-polarized beams to pass through.

When the pixels on the reflective polarization valve 30 (31, 32) are under light state, the reflective polarization valve 30 (31, 32) changes the polarity of the incident beams to P-polarized state. Meanwhile, instead of changing the polarity of the incident beams, the reflective polarization valve 30 (31, 32) reflects S-polarized beams back to the wire-grid polarizer 40 (41, 42) and passes through when the pixels are under dark state. The definition of the term ‘contract’ is the ratio of the largest luminance value and the smallest luminance value lightened on the pixels.

The color-recombining unit 61 combines the color beams reflected from the reflective polarization valve 30 (31, 32) and the wire-grid polarizer 40 (41, 42). The projecting unit projects the combined color beams to form images. An X-cube is a practical color-recombining unit 61. Polarizers 60, 62, 63 and half-wavelength lens 65, 66 are located between the color-recombining unit 61 and the wire-grid polarizer 40 (41, 42) respectively. The wire-grid polarizer can be practically used as the polarizer 60, 62, and 63. The half-wavelength lens 65, 66 are utilized for changing the directions of the color beams during the color-recombining procedure.

The projecting unit 50 is a projecting lens, used for projecting the recombined color beams from the color-recombining unit 61 onto a screen 52 to form images. In accordance with the projecting direction and the position of the screen, we can group light projectors into types of front projection and rear projection. The front-projection light projector has a projector located at the same side of the audience, with its host system and the screen separated. The rear-projection light projector is also known as projection display, with its projector and the audience located at the opposite sides of the screen.

(1) Light Path of the Blue Beam

The S-polarized white beam provided by light source 10 first passes through the dichroic mirror 20, with the blue beam reflected and the rest passing through. The blue beam, maintaining S-polarized, goes through the wire-grid polarizer 40 and projects onto the reflective polarization valve 30. Under light state, the reflective polarization valve 30 reflects P-polarized blue beam back to the wire-grid polarizer 40. Next, the blue beam is reflected and passes through the polarizer 62 and half-wavelength lens 65. The half-wavelength lens 65 transforms the P-polarized blue beam into the S-polarized state to ensure the blue beam entering the color-recombining unit 61 under S-polarized state.

(2) Light Path of the Green Beam

The beam with the blue beam sieved out, goes through the dichroic mirror 21 for sieving out the red beam and allowing the green beam to pass through. The green beam, maintaining S-polarized, goes through the wire-grid polarizer 41 and projects onto the reflective polarization valve 31. Under light state, the reflective polarization valve 31 reflects the P-polarized green beam back to the wire-grid polarizer 41. Next, the green beam is reflected and passes through the polarizer 63 for transforming any possible S-polarized light into the P-polarized state, and then enters the color-recombining unit 61.

(3) Light Path of the Red Beam

The red beam, with the blue and green beams sieved out, passes in sequence of reflector 18, focusing lens 70, reflector 19 and focusing lens 71. Next, the red beam, maintaining S-polarized, goes through the wire-grid polarizer 42 and projects onto the reflective polarization valve 32. Under light state, the reflective polarization valve 32 reflects the P-polarized red beam back to the wire-grid polarizer 41. Consequently, the red beam is reflected and passes through the polarizer 60 and half-wavelength lens 66. The half-wavelength lens 66 transforms the P-polarized red beam into the S-polarized state, to ensure the red beam entering the color-recombining unit 61 under S-polarized state.

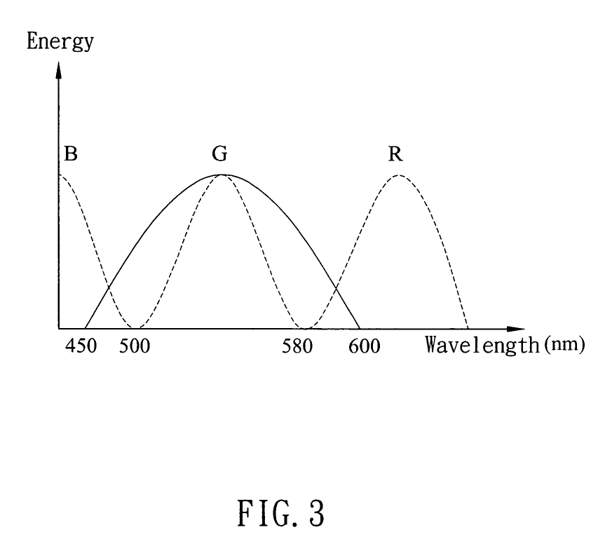

In the foregoing embodiment, the S-polarized blue and red beams proceed with color recombining with the P-polarized green beam to differentiate from all the color beams recombining under S-polarized state in the prior art. The embodiment provides images with better luminance performance and lower contract. An energy-wavelength diagram of curves is shown in FIG. 3.

The disclosed technique is suitable for any type of light projector, including front projection and rear projection without limitation in the projection display provided in the foregoing embodiment.

In short, the invention achieves advantages as follows:
a. Use of the wire-grid polarizer provides advantages of higher heat-resistance, no limitation of the incident angle and no birefringence effects, to enhance the contrast luminance of the system. Moreover, because the wire-grid polarizer allows a larger incident angle, convergent light sources such as an elliptical lamp can be applied to shorten the light paths, achieve higher efficiency and a system of smaller volume. In consequence, the wire-grid polarizer is much easier to manufacture via processes of semiconductors and has lower cost.
b. Without using peculiar optical elements such as the Color-Quad, Color-Corner or X-plate, the entire system is easy to produce with lower costs.
c. The invention applies a telecentric optical system as a light source to overcome color gradients and provides better color uniformity.
d. The elliptical lamp used in the invention has a high efficiency, small volume but no need of peculiar optical elements, to achieve simplified light paths and easy production.
e. The polarized beams of high purity proceed with color recombining right after being transformed via the reflective polarizatioin valve to provide better image performance.

Certain variations would be apparent to those skilled in the art, which variations are considered within the spirit and scope of the claimed invention.

1. A light projector using reflective polarization valve, the light projector comprising:
a light source providing a polarized white beam;
at least a dichroic mirror splitting the white beam into a plurality of color beams with different colors;
at least a reflective polarization valve receiving the polarized color beams and selectively reflecting the color beams;
at least a wire-grid polarizer located between the dichroic mirror and the reflective polarization valve, the wire-grid polarizer allowing the polarized color beams of one specific polarity to pass through and reflecting the polarized color beams of another specific polarity, the polarized color beams reflected from the reflective polarization valve under light state being reflected via the wire-grid polarizer for color recombining; and
a color-recombining unit combining the color beams reflected from the wire-grid polarizer.

2. The light projector of claim 1, wherein the reflective polarization valve is LCOS.

3. The light projector of claim 1, wherein the white beams is S-polarized.

4. The light projector of claim 1, wherein each of the color beams enters the color-recombining unit after pass through a polarizer respectively, thereby to ensure the color beams under light state while entering the color-recombining unit to achieve a high color contrast.

5. The light projector of claim 4, wherein the polarizer is also the wire-grid polarizer.

6. The light projector of claim 1, further comprising a focusing lens located in front of the reflective polarization valve to focus the color beams thereon.

7. The light projector of claim 1, wherein the light source is a telecentric optical system.

8. The light projector of claim 1, wherein the light source comprises a white lamp, a divergent lens, at least a lens array and a P/S Converter.

9. The light projector e of claim 1, wherein the white beam generated from the white lamp first pass through the divergent lens, and then the lens array and the P/S Converter to provide the S-polarized parallel white beam.

10. The light projector of claim 8, further comprising a half-wavelength lens located in front of the color-recombining unit respectively in a red light path and a blue light path, a blue beam and a red beam entering the color-recombining unit under S-polarized state, a green beam entering the color-recombining unit under P-polarized state.

11. The light projector of claim 8, wherein the white lamp is an elliptical lamp.

12. A projection display using reflective polarization valve, the projection display comprising:
a light source providing a polarized white beam;
at least a dichroic mirror splitting the white beam into a plurality of color beams with different colors;
at least a reflective polarization valve receiving the polarized color beams and selectively reflecting the color beams;
at least a wire-grid polarizer located between the dichroic mirror and the reflective polarization valve, the wire-grid polarizer allowing the polarized color beams of one specific polarity to pass through and reflecting the polarized color beams of another specific polarity, the polarized color beams reflected from the reflective polarization valve under light state being reflected via the wire-grid polarizer for color recombining;
a color-recombining unit combining the color beams reflected from the wire-grid polarizer; and a projecting unit projecting the combined color beams to form images.

13. The projection display of claim 12, wherein the reflective polarization valve is LCOS.

14. The projection display of claim 12, wherein the white beams is S-polarized.

15. The projection display of claim 12, wherein each of the color beams enters the color-recombining unit after pass through a polarizer respectively, thereby to ensure the color beams under light state while entering the color-recombining unit to achieve a high color contrast.

16. The projection display of claim 15, wherein the polarizer is also the wire-grid polarizer.

17. The projection display of claim 12, further comprising a focusing lens located in front of the reflective polarization valve to focus the color beams thereon.

18. The projection display of claim 12, wherein the light source is a telecentric optical system.

19. The projection display of claim 12, wherein the light source comprises a white lamp, a divergent lens, at least a lens array and a P/S Converter.

20. The projection display of claim 12, further comprising a half-wavelength lens located in front of the color-recombining unit respectively in a red light path and a blue light path, a blue beam and a red beam entering the color-recombining unit under S-polarized state, a green beam entering the color-recombining unit under P-polarized state.

21. The projection display of claim 19, wherein the white lamp is an elliptical lamp.
